(19) United States
(12) Patent Application Publication
(10) Pub. No.: US 2008/0079637 A1
(43) Pub. Date: Apr. 3, 2008

(54) ANTENNA APPARATUS

(75) Inventors: Shinichiro Okamura, Kyoto-shi (JP); Sumifumi Oki, Kumamoto-ken (JP)

Correspondence Address: OSHA LIANG L.L.P., 1221 MCKINNEY STREET, SUITE 2800, HOUSTON, TX, 77010, US

(73) Assignee: OMRON CORPORATION, Kyoto-shi (JP)

(21) Appl. No.: 11/860,967

(22) Filed: Sep. 25, 2007

(30) Foreign Application Priority Data
Sep. 28, 2006 (JP) 2006-265147

(51) Int. Cl. H01Q 1/38

(52) U.S. Cl. 343/700 MS

(57) ABSTRACT

An antenna apparatus includes a radiation member and a substrate having a ground conductor. The radiation member has a plate-like shape, is made of a dielectric material, and includes a radiation conductor. The radiation member is joined to a surface of the substrate. The radiation conductor includes a feeding portion, at least a pair of notch portions, and a step. The feeding portion is exposed from a center at one end of the dielectric material and coupled to a feeding pad provided in the substrate. The notch portions are symmetrically formed. The step is formed by a bend between the feeding portion and one of the notch portions. The radiation conductor on a side of the feeding portion from the step is embedded in the dielectric material.

### BACKGROUND OF THE INVENTION

1. Field of the Invention

The present invention relates to an antenna apparatus.

2. Description of the Related Art

For example, as disclosed in Japanese Patent Application Laid-Open No. 2006-186969, there is known an antenna apparatus which has a radiation conductor and a ground conductor in a surface of a dielectric material. In such an antenna apparatus, reception sensitivity can be decreased in a specific frequency band by cutting away the radiation conductor.

In the conventional antenna apparatus, because the radiation conductor formed by a metal plate is disposed on the surface of the dielectric material, sometimes the radiation conductor is peeled off from the dielectric material when a shock is applied to the antenna apparatus due to falling.

### SUMMARY OF THE INVENTION

In view of the foregoing, an object of the present invention is to provide an antenna apparatus in which the radiation conductor is never peeled off from the dielectric material even when a shock is applied.

An antenna apparatus according to an aspect of the present invention in which a plate-shaped radiation member including a radiation conductor is joined to a surface of a substrate having a ground conductor, the radiation member being made of a dielectric material, wherein the radiation conductor includes a feeding portion, at least a pair of notch portions, and a step, the feeding portion being exposed from a center at one end of the dielectric material while coupled to a feeding pad provided in the substrate, the notch portions being symmetrically formed, the step being formed by bending between the feeding portion and the notch portion located farthest from the feeding portion, and the radiation conductor on a side of the feeding portion from the step is embedded in the dielectric material.

According to the configuration of the aspect of the present invention, because the radiation conductor on the feeding portion side is embedded in the dielectric material, the radiation conductor is never peeled off from the dielectric material by a shock transmitted from the feeding portion.

In the antenna apparatus according to the aspect of the present invention, a plurality of the pairs of notch portions are preferably formed, and the step is preferably formed at the second pair of notch portions from the feeding portion.

According to the above configuration, a width of a portion where the radiation conductor intrudes into the inside from the surface of the dielectric material can be narrowed by providing the step at the second pair of notch portions from the feeding portion. Therefore, both sides of the portion where the radiation conductor intrudes into the dielectric material, i.e., a surface layer and a back layer of the dielectric material are coupled to each other at the notch portion, and a crack is hardly generated in the dielectric material.

In the antenna apparatus according to the aspect of the present invention, the radiation conduction on a side of the feeding portion from the step is preferably embedded in the radiation member at a center in a thickness direction.

According to the above configuration, neither of the surface layer nor the back layer becomes thin in the dielectric material sandwiching the radiation conductor, so that the strength of the dielectric material is not lost.

In the antenna apparatus according to the aspect of the present invention, a plurality of the pairs of notch portions are preferably formed, and the second pair of notch portions from the feeding portion is preferably formed into a round notch.

According to the above configuration, the sensitivity of a relatively long wavelength range (low frequency range) can be lowered widely.

In the antenna apparatus according to the aspect of the present invention, an end face on a surface side of the step portion is chamfered in the radiation conductor.

According to the above configuration, in the portion where the radiation conductor intrudes into the dielectric material, a corner is not formed in the dielectric material, which allows stress concentration to be lessened to prevent a crack of the dielectric material.

Thus, according to the present invention, because the radiation conductor on the feeding portion side is embedded in the dielectric material, the radiation conductor is hardly peeled off from the dielectric material when a shock is applied to the antenna apparatus.

### BRIEF DESCRIPTION OF THE DRAWINGS

FIG. 1 shows a perspective view of an antenna apparatus according to a first embodiment of the present invention;

FIG. 2 shows a perspective view illustrating a radiation member of the antenna apparatus of FIG. 1;

FIG. 3 shows a front view of the radiation member of FIG. 2;

FIG. 4 shows a side view of the radiation member of FIG. 2;

FIG. 5 shows an input characteristic chart of the antenna apparatus of FIG. 1;

FIG. 6 shows a perspective view of a radiation member of an antenna apparatus according to a second embodiment of the invention;

FIG. 7 shows a front view of the radiation member of FIG. 6;

FIG. 8 shows a partially cross-sectional view in a step portion of a radiation conductor of the radiation member of FIG. 6;

FIG. 9 shows a partially cross-sectional view in a round hole of the radiation conductor of the radiation member of FIG. 6;

FIG. 10 shows a partially cross-sectional view illustrating a modification of the round hole of FIG. 9;

FIG. 11 shows a perspective view illustrating a first sample of a verification experiment of the present invention;

FIG. 12 shows a perspective view illustrating a second sample of the verification experiment of the present invention;

FIG. 13 shows a perspective view illustrating a third sample of the verification experiment of the present invention;

FIG. 14 shows a perspective view illustrating a fourth sample of the verification experiment of the present invention;

FIG. 15 shows a perspective view illustrating a fifth sample of the verification experiment of the present invention;

FIG. 16 shows a perspective view illustrating a comparative sample of the verification experiment of the present invention;

FIG. 17 shows a graph illustrating results of the verification experiment of the present invention; and

FIG. 18 shows an input characteristic chart of the antenna apparatus in which the samples of FIGS. 11 to 16 are used.

### DETAILED DESCRIPTION OF THE PREFERRED EMBODIMENTS

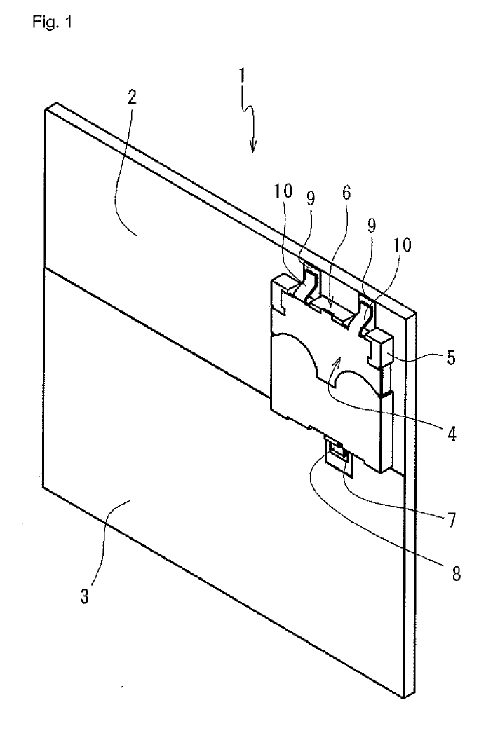

Preferred embodiments of the present invention will be described below with reference to the drawings. FIG. 1 shows an antenna apparatus 1 according to a first embodiment of the present invention. In the antenna apparatus 1, a ground conductor 3 formed by a metal layer is formed on a surface of a substrate 2, and a radiation member 6 is disposed in parallel with the ground conductor 3. In the radiation member 6, a radiation conductor 4 formed by a metal plate is inserted, and a dielectric material 5 is molded in a plate shape.

The radiation conductor 4 includes a feeding portion 8 and two fixed portions 10. The feeding portion 8 is projected from the center of a lower end of the dielectric material 5, and the feeding portion 8 is connected to a feeding pad 7 formed in the substrate 2. The fixed portions 10 are fixed to fixed pads 9 formed on the substrate 2. The feeding pad 7 feeds electric power to the radiation conductor 4. The fixed pad 9 mechanically fixes the fixed portion 10, and the fixed pad 9 is formed by a metal layer electrically separated from other components.

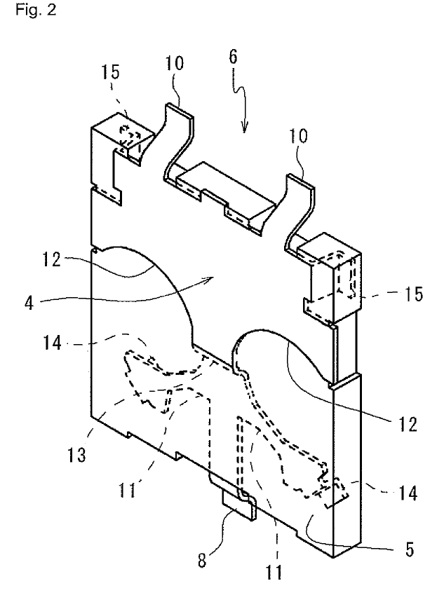

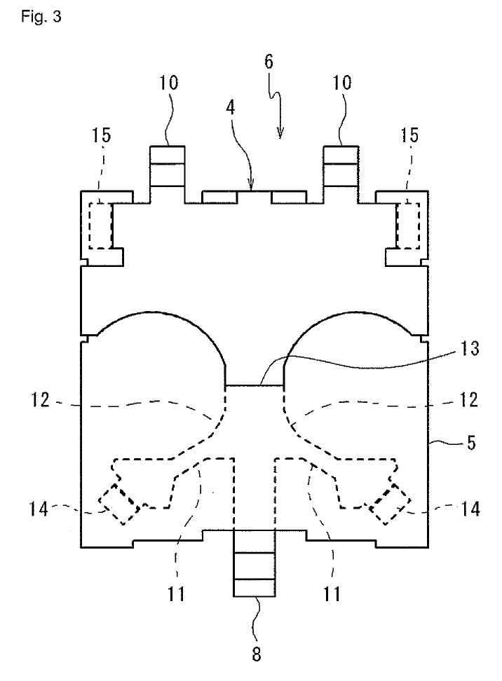

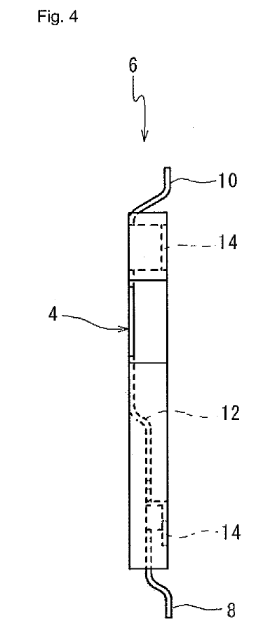

FIGS. 2 to 4 show details of the radiation member 6. The radiation conductor 4 includes first notch portions 11 and second notch portions 12. The first notch portions 11 are formed by symmetrically cutting away both sides of the feeding portion 8, and the second notch portions 12 are formed by cutting away the radiation conductor 4 from both sides in a substantially circular shape. The radiation conductor 4 also includes a step portion 13 in which the radiation conductor 4 is bent at the substantial center between the second notch portions 12 to form a step on the plate surface. The radiation conductor 4 on the side from the step portion 13 to the feeding portion 8 is embedded in the dielectric material 5 at the substantial center in a thickness direction of the radiation member 6. Additionally, in the radiation conductor 4, front ends of the first notch portion 11 are folded to form anchor portions 14, and both ends of upper portions of the second notch portions 12 are folded to form anchor portions 15. The anchor portions 14 and the anchor portions 15 are exposed to the back side of the radiation member 6.

A metal such as copper and phosphor bronze is suitable as the radiation conductor 4, and examples of the dielectric material 5 include polyphenyl sulfide (PPS), polybuthylene terephthalate (PBT), a liquid crystal polymer (LCP), polypropylene (PP), an epoxy resin (EP), syndiotactic polystyrene (SPS), polycarbonate (PC), polyethylene terephthalate (PET), polyimide (PI), polyether imide (PEI), and a phenol resin (PF).

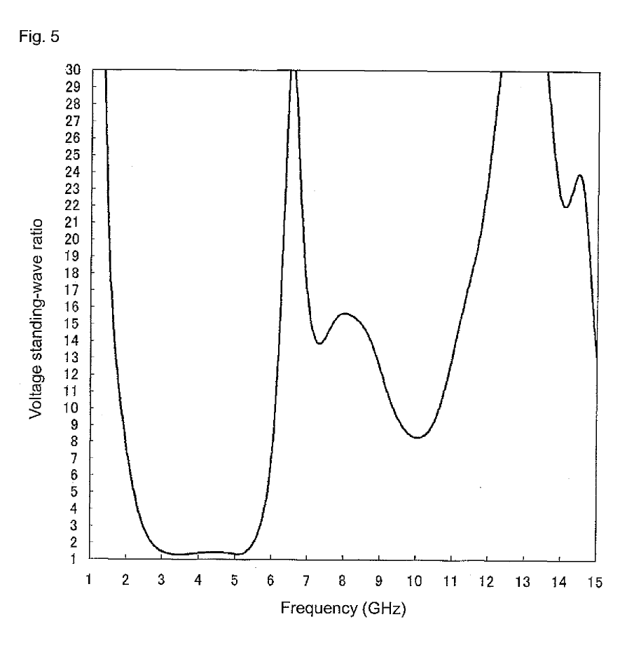

FIG. 5 shows input characteristics of the antenna apparatus 1. The antenna apparatus 1 is designed as a UWB standard antenna apparatus such that a passing band is set to a frequencies ranging from 3.1 GHz to 4.9 GHz, and a cutoff band is set to other frequencies. The first notch portion 11 of the radiation conductor 4 mainly decreases the reception sensitivity in the band of 10 to 15 GHz (i.e., forms the cutoff band in the band of 10 to 15 GHz), while the second notch portion 12 decreases the reception sensitivity in the band of 6 to 10 GHz. Generally, it is known that the notch portions 11 and 12 cut off the higher-frequency (shorter wavelength) band as the notch portions 11 and 12 are brought closer to the feeding portion 8. Particularly, the low-frequency cutoff band is set wide by largely cutting away the second notch portion 12 in a substantially circular shape.

In the radiation member 6 according to the present embodiment, when the antenna apparatus 1 falls, the shock is mainly transmitted from the substrate 2 to the feeding portion 8 and the fixed portion 10. In the present embodiment, even if the shock is applied to the feeding portion 8, because the lower portion of the radiation conductor 4 is sandwiched within the dielectric material 5, the radiation conductor 4 is not peeled off from the dielectric material 5 to drop from the radiation member 6. Even if the shock is applied to the fixed portion 10, the anchor portion 15 prevents the radiation conductor 4 from being peeled off from the dielectric material 5 to drop from the radiation member 6. Therefore, in the antenna apparatus 1 according to the present embodiment, the radiation conductor 4 is never peeled off from the dielectric material 5 due to the shock, and the breakage hardly occurs.

The dielectric material 5 sandwiching the radiation conductor 4 on the side of the feeding portion 8 is divided into the surface layer and the back layer, and the surface layer and the back layer are integrally connected to retain the radiation conductor 4 at the second notch portion 12. That is, the narrow step portion 13 is formed between the second notch portions 12 to decrease the width of the portion where the radiation conductor 4 intrudes into the inside from the surface of the radiation member 6, and the surface layer and back layer of the dielectric material 5 are firmly connected on both sides of the step portion 13. This enables the breakage of the dielectric material 5 to be prevented to improve the shock resistance of the radiation member 6.

Additionally, because the radiation conductor 4 on the side of the feeding portion 8 is embedded at the center in the thickness direction of the radiation member 6, both the surface layer and the back layer of the dielectric material 5 are formed so as not to be excessively thin, and the radiation member 6 has sufficient mechanical strength and shock resistance.

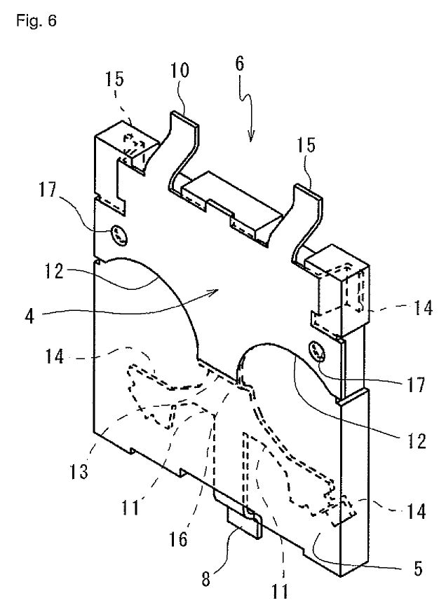

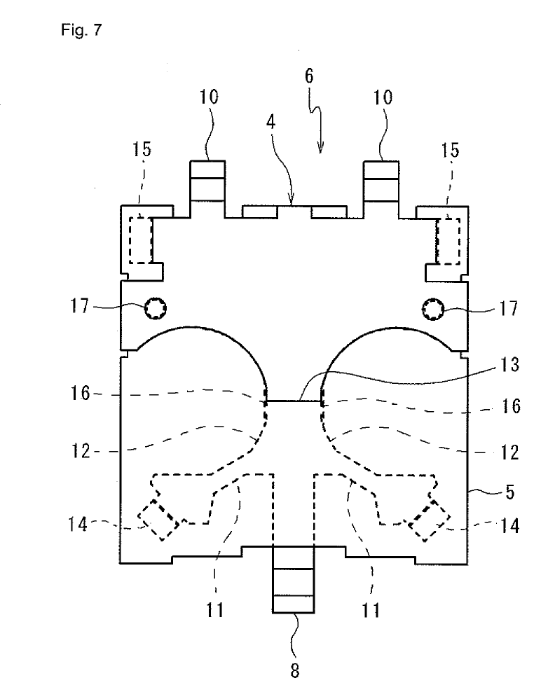

FIGS. 6 and 7 show a radiation member 6 of an antenna apparatus 1 according to a second embodiment of the present invention. In the second embodiment, the same component as the first embodiment is designated by the same reference numeral, and the description thereof is omitted. In the radiation conductor 4 of the radiation member 6, chamfering 16 is performed on the surface side at end face of each of both sides of the step portion 13, and tapered round holes 17 are made above the second notch portions 12. The diameter of the round hole 17 is enlarged toward the surface.

FIG. 8 shows a cross section of the radiation member 6 at the step portion 13. As shown in FIG. 8, a corner is not formed in the dielectric material 5 by the chamfering 16 in the portion where the radiation conductor 4 intrudes into the dielectric material 5. Therefore, the stress concentration is lessened so that a crack in the dielectric material 5 is hardly generated.

FIG. 9 shows a cross section at a round hole 17 of the radiation member 6. The diameter of the round hole 17 is enlarged toward the surface, so that the dielectric material 5 with which the inside of the round hole 17 is filled during the molding can prevent the peel-off of the radiation conductor 4.

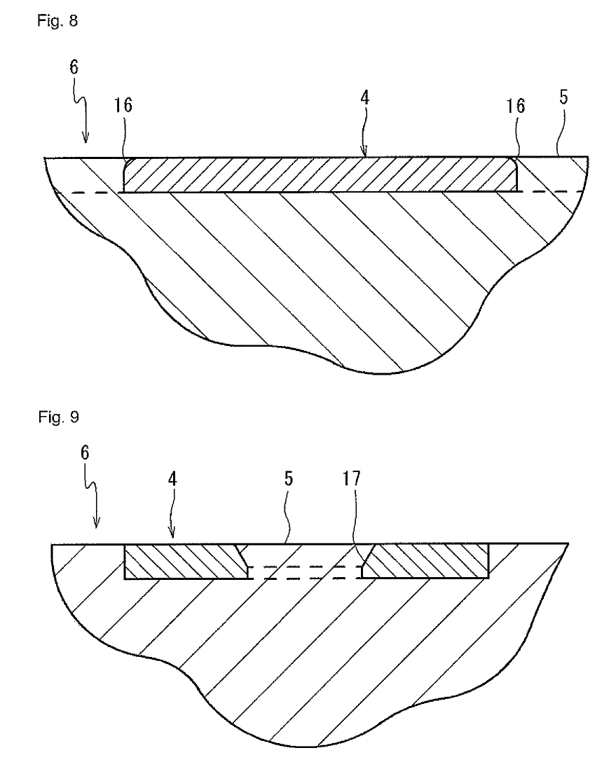

In a modification of the round hole 17, burring 18 may be performed on the radiation conductor 4 as shown in FIG. 10.

(Experimental Example)

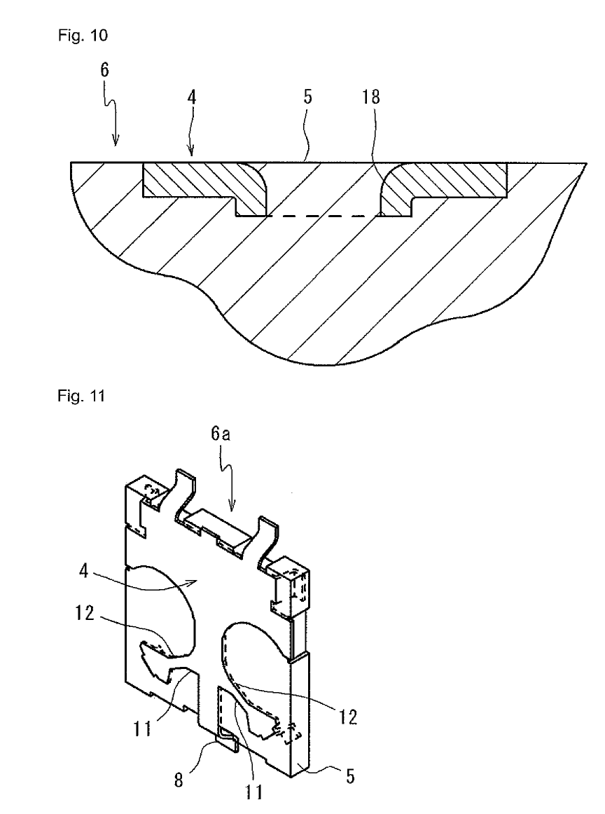

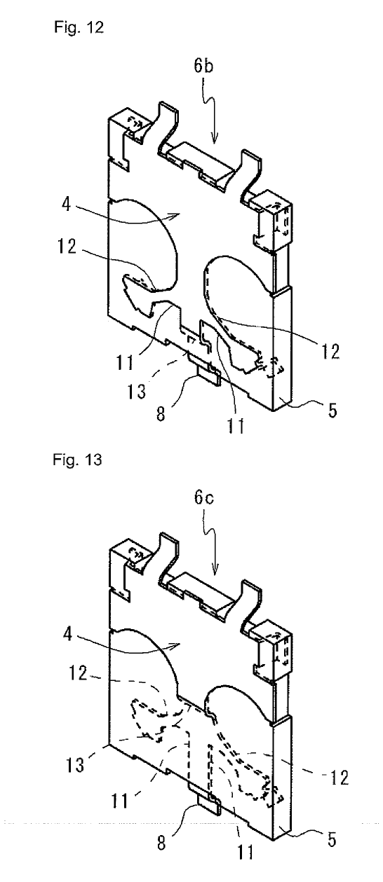

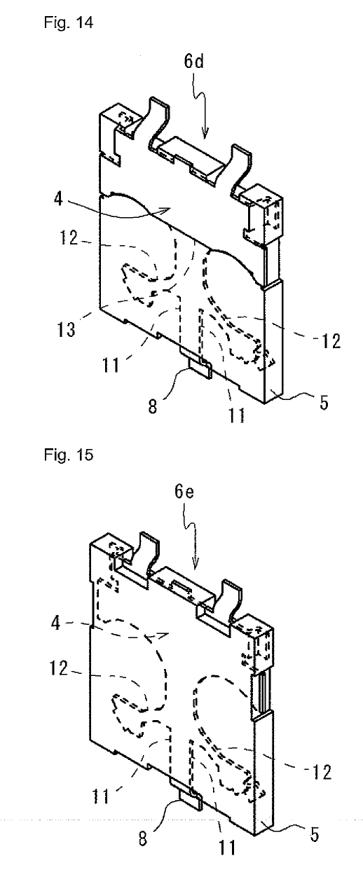

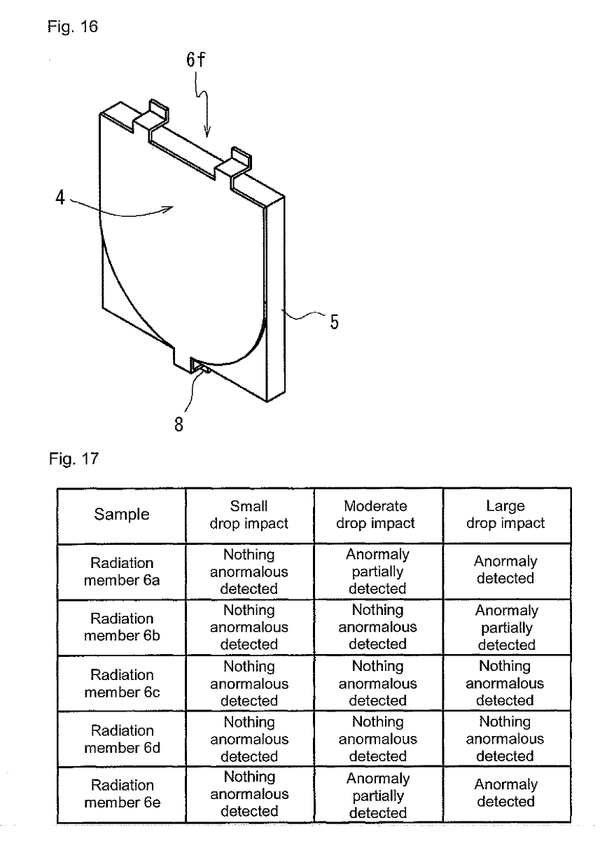

Verification experiments of the present invention will be described below. FIGS. 11 to 16 show radiation members 6a to 6f used in the verification experiments respectively. The radiation members 6a to 6e have the radiation conductors 4 in which the notch portions 11 and 12 having the same shape as the first embodiment are formed, although the radiation members 6a to 6e differ from one another in the position where the step portion 13 is provided.

In the radiation member 6a, the radiation conductor 4 has no step, and the whole surface of the radiation conductor 4 is disposed on the surface of the dielectric material 5. In the radiation member 5b, the step portion 13 is provided in the first notch portion 11 of the radiation conductor 4, and only the lower end of the radiation conductor 4 is embedded in the radiation member 6b. The radiation member 6c is the first embodiment, and the step portion 13 is provided at the center of the second notch portion 12 of the radiation conductor 4. In the radiation member 6d, the step portion 13 is provided at a top end of the second notch portion 12 of the radiation conductor 4. In the radiation member 6e, there is no step in the radiation conductor 4, and the whole of the radiation conductor 4 is embedded in the radiation member 6e at the center in the thickness direction. The radiation member 6f is prepared as a comparative example of the input characteristics. In the radiation member 6f, the conventional radiation conductor 4 in which the notch portions 11 and 12 are not formed is joined to the surface of the dielectric material 5.

FIG. 17 shows the result of a drop test. The predetermined number of samples was prepared for the radiation members 6a to 6e, and the drop test was performed predetermined times under predetermined conditions. In the case of the small drop impact, no broken sample was observed for all the radiation members 6a to 6e. In the case of the moderate drop impact, the peel-off of the radiation conductor 4 and the cracks of the radiation members 6a and 6e were observed in some of the samples of the radiation members 6a and 6e. When the drop impact was further increased, the breakage was observed in a considerable number of samples for the radiation members 6a and 6e, and the breakage was also observed in some of samples for the radiation member 6b. However, even in the case of the maximum drop impact, the breakage was not observed in the radiation members 6c and 6d in which the step is provided at the second notch portion 12.

As a result of the verification experiment, the following fact was confirmed. That is, in the present invention, the step portion 13 is formed in the range between the second notch portion 12 and the feeding portion 8, and a portion of the radiation conductor 4 is disposed inside the radiation member 6. Therefore, the strength of the antenna apparatus 1 can be enhanced, and it is preferred that the step portion 13 is formed at the second pair of the notch portions 12 from the feeding portion 8.

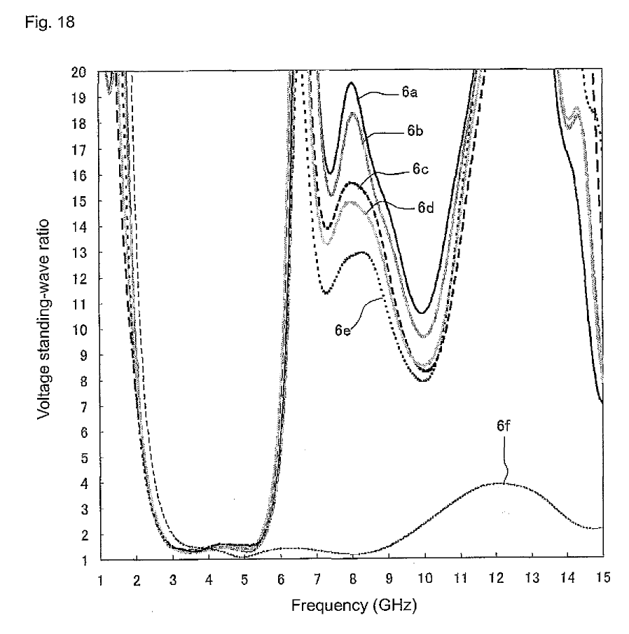

FIG. 18 shows an effect on the input characteristics of the antenna apparatus 1 by providing the step portion 13 to embed the radiation conductor 4 in the radiation member 6. Referring to FIG. 18, as a ratio at which the radiation conductor 4 is embedded in the radiation member 6 is increased, the cutoff performance is decreased in the range of 6 to 10 GHz. However, the decrease in cutoff performance is not significant, but the input characteristics of the antenna apparatus 1 are sufficient for practical use.

What is claimed is:

1. An antenna apparatus comprising:
a radiation member including a radiation conductor, the radiation member having a plate-like shape and being made of a dielectric material; and
a substrate having a ground conductor, the radiation member being joined to a surface of the substrate,
wherein the radiation conductor includes a feeding portion, at least a pair of notch portions, and a step, the feeding portion being exposed from a center at one end of the dielectric material while coupled to a feeding pad provided in the substrate, the notch portions being symmetrically formed, the step being formed by bending between the feeding portion and the notch portion located farthest from the feeding portion, and the radiation conductor on a side of the feeding portion from the step is embedded in the dielectric material.

2. The antenna apparatus according to claim 1, wherein a plurality of the pairs of notch portions are formed, and the step is formed at the second pair of notch portions from the feeding portion.

3. The antenna apparatus according to claim 1, wherein the radiation conductor on the side of the feeding portion from the step is embedded in the radiation member at a center in a thickness direction.

4. The antenna apparatus according to claim 1, wherein a plurality of the pairs of notch portions are formed, and the second pair of notch portions from the feeding portion is formed into a round notch.

5. The antenna apparatus according to claim 1, wherein an end face on a surface side of the step portion is chamfered in the radiation conductor.
